(19) United States
(12) Patent Application Publication
(10) Pub. No.: US 2012/0210351 A1
(43) Pub. Date: Aug. 16, 2012

(54) PRESENTATION OF CUSTOMIZED DIGITAL MEDIA PROGRAMMING

(75) Inventors: Chandrasekhar Nukala, Redmond, WA (US); David Callaghan, Kirkland, WA (US)

(73) Assignee: MICROSOFT CORPORATION, Redmond, WA (US)

(21) Appl. No.: 13/026,068

(22) Filed: Feb. 11, 2011

(51) Int. Cl. H04N 7/173; H04N 7/10

(52) U.S. Cl. 725/35; 725/93

(57) ABSTRACT

In one disclosed embodiment, presentation of customized programming includes receiving an input of information related to a first digital media content series from which to obtain an episode for inclusion as a first segment in a customized programming presentation for a user, receiving an input of information related to a second digital media content series from which to obtain an episode for inclusion as a second segment in the customized programming presentation, and storing the information in a data structure representing customized digital media programming for the user. The embodiment further includes receiving from the user an input of a request to play the customized programming presentation, obtaining an episode of the first digital media content series, obtaining an episode of the second digital media content series, and providing the episodes within the customized programming presentation.

### BACKGROUND

Currently, television viewers can access multiple channels each presenting a variety of content throughout the day and week. However, due to the broadcast distribution model of television, content is generally pre-scheduled. Thus, users often must wait for content of interest to become available for consumption. Pay-per-view and other such on-demand services allow the viewing of some types of content at any desired time, but content available via such services may be limited. Digital video recorders (DVRs) may allow time-shifted content viewing, as well as seeking for desired content within a television program (e.g., a sports segment in a news broadcast), and thus permit a somewhat greater degree of consumer control over content viewing than traditional broadcast television. All of these scenarios rely on traditional broadcast model where the studio/producer attempt to meet specific demographic needs with content that appeals to the widest possible audience.

Video content available via the internet currently may allow a greater degree of customization. For example, some video hosting websites may allow a user to add specific video selections to a queue such that the videos are played contiguously in the order specified by the queue. After viewing, the videos are removed from the queue. Internet sites also bypass the traditional studio production model wherein users can directly upload content to the sites which are rebroadcast.

### SUMMARY

Various embodiments are disclosed herein that relate to the customized programming of digital media content. For example, one disclosed embodiment provides, on a computing device, a method of presenting digital media content. The method comprises receiving an input of information related to a first digital media content series from which to obtain an episode for inclusion as a first segment in a customized programming presentation for a user, receiving an input of information related to a second digital media content series from which to obtain an episode for inclusion as a second segment in the customized programming presentation, and storing the information related to the first digital media content series and the information related to the second digital media content series in a data structure representing customized digital media programming for the user. The method further comprises receiving from the user an input of a request to play the customized programming presentation, obtaining an episode of the first digital media content series, obtaining an episode of the second digital media content series, and providing the episode of the first digital media content series and the episode of the second digital media content series within the customized programming presentation.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows an embodiment of a digital media consumption environment.

FIG. 2 shows a flow diagram depicting an embodiment of a method of presenting customized digital media content programming

FIG. 3 shows a schematic depiction of an embodiment of customized digital media programming comprising a plurality of customized programming presentations for a plurality of consumption platforms.

FIGS. 4A-4C show a flow diagram depicting another embodiment of a method of presenting customized digital media content programming.

### DETAILED DESCRIPTION

As mentioned above, current video consumption platforms may not allow a user to easily view content customized for the individual preferences at the desired time. For example, in traditional broadcast television, a user generally must wait until a scheduled broadcast time to view desired content. DVRs and other recording devices allow users to time-shift content viewing, and to seek and skip through a recorded content item to view segments of interest within the content item. However, the content that is recorded is that which is broadcast over the entire network, rather than content that is customized and provided based upon each viewer's particular interests.

Internet television and video services may allow a user more leeway in choosing what content to watch, as well as when to watch the content. For example, a user may view an internet television show by logging onto a network-accessible website and then viewing a show available on the website via a media player on the user's computing device. However, in order to view different shows on different websites, a user manually navigates between websites and manually initiates playback of each desired media content item on each website. In addition to downloading or streaming content from a specific website, users can subscribe to peer to peer networks which distribute files containing content as well as provide streaming capabilities for live as well as recorded content.

Accordingly, embodiments are disclosed herein that allow media consumers to set up customized digital media programming, and to consume customized programming presentations defined by the customized programming. The customized digital media programming allows users to view any desired arrangement of network-accessible content in any desired order, at any desired time, thus delivering a media product/experience that is individually targeted in a manner not offered by traditional broadcast television. Content from multiple different content sources at different network locations may be viewed as a contiguous presentation that does not need to be manually re-queued after each presentation. Furthermore, the content may be filtered to meet desired criteria, such as length, content type (e.g. as defined by keywords, parental control ratings, etc.), and/or any other suitable criteria.

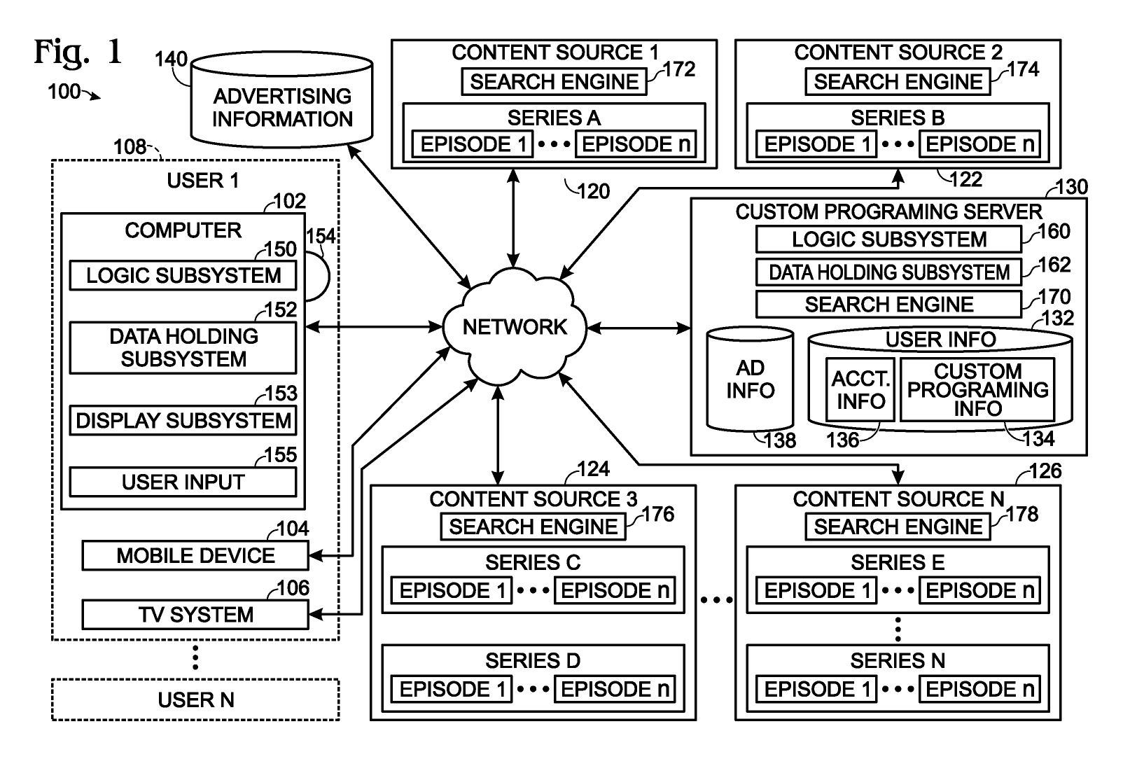

FIG. 1 shows an example embodiment of a network media consumption environment 100 comprising a plurality of end-user computing devices including a computer 102, a mobile device 104, and a television system 106 operated by a first user 108, labeled user 1. FIG. 1 also illustrates that an arbitrary number of users N may consume media via media consumption environment 100, wherein each user accesses the consumption environment 100 via one or more different computing devices.

It will be understood that computer 102, mobile device 104, and television system 106 may represent any suitable types of computing devices. Example computers 102 include, but are not limited to, laptop computers, desktop computers, notepad computers, notebook computers, slate computers, mainframe computers, server computers, and/or any other suitable types of computers. Example mobile devices include, but are not limited to, smart phones and other cellular phones, portable media players, portable game systems, etc. Likewise, example television systems 106 may include hardware such as digital video recorders, set-top boxes, video game consoles, and other network devices and/or home entertainment devices.

Media consumption environment 100 also comprises a plurality of media content sources, illustrated as content source 1 120, content source 2 122, content source 3 124, and content source N 126. Each content source comprises one or more digital media content series stored thereon, wherein each digital media content series comprises one or more episodes. For example, media content source 1 comprises episodes 1 through n of series A. In FIG. 1, content source 1 and content source 2 are each depicted as having one series (series A and series B, respectively), content source 3 is depicted as having two series, and content source 4 is depicted as having an arbitrary number of series.

Content sources 120-126 may take any suitable form. For example, some content sources may be operated by large media production and/or provision companies, such as network television companies, local television stations, and other relatively large media companies. Such media companies may offer a variety of content series of different types. In contrast, other content sources may be run by individuals or small organizations that offer one, or a few, content series.

Content sources 120-126 provide metadata and discovery services describing the site content to enable clients search, find, and download content they are interested in observing, as shown by search engines 172, 174, 176, 178 illustrated within the content sources 120-126. A content source may support public or member upload features where users tag the content with metadata which is later used to match the content with new viewers. In addition the server or clients may run video or audio analysis on the content to determine if it matches specific patterns. For example black and white vs. color video, or by applying image recognition software to the images present to support an accurate catalog of the video streams.

The term “series” as used herein may signify any suitable type of available content, and may be similar to or different than series available by current broadcast television. For example, in broadcast television, the term “series” generally refers to a set of periodically presented content items that are related to one another via content, cast, producer, title, and/or other such factors. Episodes of conventional broadcast television series are generally broadcast at a designated periodic time slot, and are configured, together with advertising, to occupy the allotted time slot in the broadcast schedule.

In contrast, episodes of “series” as used herein may have varying length, and may or may not be produced on a regular schedule. Further, episodes of series may be shorter, and potentially significantly shorter, than typical broadcast television time slots, which often have a half hour minimum length. An episode of a series as contemplated herein may have a length of a few minutes, and may correspond to a single segment of a longer broadcast media episode. For example, a weather segment of a traditional news report may correspond to a single “episode” of a weather report series. Likewise, an “episode” as used herein also may signify a specific time window that defines a portion of content of interest from a longer traditional broadcast media episode (e.g. five minutes of sports from a thirty minute television news broadcast).

As described in more detail below, a user may define customized programming that comprises a plurality of customized programming selections, where each customized programming selection comprises a list of two or more content series from which episodes may be obtained and assembled to present an instance of a selected customized programming presentation. Thus, a user may combine any desired arrangement of content series into a customized television program in which episodes of the series in the list are obtained and played as a contiguous presentation (such that a viewer does not manually navigate to different content providers to obtain the episodes of different series within the presentation). When the user selects to play the customized program, unviewed episodes of each specified series may be downloaded for presentation to the user. The user's progress through a series can be stored on the device to resume content later on as well as prevent showing identical content based merely upon search engine ranking of results matching the input queries.

Continuing with FIG. 1, media consumption environment 100 comprises a custom programming server 130 configured to receive, store, and provide customized digital media programming definitions from users. For example, in some embodiments, custom programming server 130 may be configured to process metadata corresponding to the customized programming and present the relevant content. As such, custom programming server 130 comprises a user information store 132 for storing such information as custom programming information 134 and user account information 136 for each registered user. The user account information may include any suitable information. Examples of user account information include, but are not limited to, user login information, user demographic information for identifying advertising to present to users, attributes related to the content viewed such as sports, drama, information topics and information on devices associated with each user. Custom programming server 130 also may comprise an advertising information store 138 containing advertising content, or may otherwise be configured to access remotely stored advertising information 140.

As illustrated for computer 102, each computing device may include a logic subsystem 150 and a data-holding subsystem 152, wherein the logic subsystem 150 is configured to execute instructions stored within the data-holding subsystem 152 to, among other tasks, implement embodiments disclosed herein. The device data holding subsystem 152 can be leveraged to maintain state of previous queries and results presented to the user to prevent showing duplicates or nearly duplicate content from different sources. Likewise, the custom programming server also comprises a logic subsystem 160 and data-holding subsystem 162.

Each computing device further may include a display subsystem 153, communication subsystem (not shown), user input devices 155 such as keyboards, mice, game controllers, cameras, microphones, and/or touch screens, as well as any other suitable components not shown in FIG. 1.

Logic subsystem 150 (and the logic subsystem 160 of the server 130) may include one or more physical devices configured to execute one or more instructions. For example, the logic subsystem 150 may be configured to execute one or more instructions that are part of one or more applications, services, programs, routines, libraries, objects, components, data structures, or other logical constructs. Such instructions may be implemented to perform a task, implement a data type, transform the state of one or more devices, or otherwise arrive at a desired result.

The logic subsystem 150 may include one or more processors that are configured to execute software instructions. Additionally or alternatively, the logic subsystem 150 may include one or more hardware or firmware logic machines configured to execute hardware or firmware instructions. Processors of the logic subsystem 150 may be single core or multicore, and the programs executed thereon may be configured for parallel or distributed processing. The logic subsystem 150 may optionally include individual components that are distributed throughout two or more devices, which may be remotely located and/or configured for coordinated processing. One or more aspects of the logic subsystem 150 may be virtualized and executed by remotely accessible networked computing devices configured in a cloud computing configuration.

The data-holding subsystem 152 (and the data-holding subsystem 162 of the server) may include one or more physical, non-transitory, devices configured to hold data and/or instructions executable by the logic subsystem 150 to implement the herein described methods and processes. When such methods and processes are implemented, the state of the data-holding subsystem 152 may be transformed (e.g., to hold different data).

The data-holding subsystem 152 may include removable media and/or built-in devices. The data-holding subsystem 152 may include optical memory devices (e.g., CD, DVD, HD-DVD, Blu-Ray Disc, etc.), semiconductor memory devices (e.g., RAM, FLASH MEMORY, PRAM, EPROM, EEPROM, etc.) and/or magnetic memory devices (e.g., hard disk drive, floppy disk drive, tape drive, MRAM, etc.), among others. The data-holding subsystem 152 may include devices with one or more of the following characteristics: volatile, nonvolatile, dynamic, static, read/write, read-only, random access, sequential access, location addressable, file addressable, and content addressable. In some embodiments, the logic subsystem 150 and the data-holding subsystem 152 may be integrated into one or more common devices, such as an application specific integrated circuit or a system on a chip.

FIG. 1 also shows an aspect of the data-holding subsystem in the form of removable computer-readable storage media 154, which may be used to store and/or transfer data and/or instructions executable to implement the herein described methods and processes. The removable computer-readable storage media 154 may take the form of CDs, DVDs, HD-DVDs, Blu-Ray Discs, EEPROMs, and/or floppy disks, among others.

It is to be appreciated that the data-holding subsystem 152 includes one or more physical, non-transitory devices. In contrast, in some embodiments aspects of the instructions described herein may be propagated in a transitory fashion by a pure signal (e.g., an electromagnetic signal, an optical signal, etc.) that is not held by a physical device for at least a finite duration. Furthermore, data and/or other forms of information pertaining to the present disclosure may be propagated by a pure signal.

The terms “module,” “program,” and “engine” may be used to describe an aspect of the disclosed computing devices that is implemented to perform one or more particular functions. In some cases, such a module, program, or engine may be instantiated via the logic subsystem 150 executing instructions held by the data-holding subsystem 152. It is to be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” are meant to encompass individual or groups of executable files, data files, libraries, drivers, scripts, database records, etc.

It is to be appreciated that a “service”, as used herein, may be an application program executable across multiple user sessions and available to one or more system components, programs, and/or other services. In some implementations, a service may run on a server responsive to a request from a client.

When included, the display subsystem 153 may be used to present a visual representation of data held by data-holding subsystem 152. As the herein described methods and processes change the data held by the data-holding subsystem 152, and thus transform the state of the data-holding subsystem 152, the state of the display subsystem 153 may likewise be transformed to visually represent changes in the underlying data. The display subsystem 153 may include one or more display devices utilizing virtually any type of technology. Such display devices may be combined with the logic subsystem 150 and/or the data-holding subsystem 152 in a shared enclosure, or such display devices may be peripheral display devices.

The communication subsystem (not shown) may be configured to communicatively couple computer 102 with one or more other computing devices. The communication subsystem may include wired and/or wireless communication devices compatible with one or more different communication protocols. As nonlimiting examples, the communication subsystem may be configured for communication via a wireless telephone network, a wireless local area network, a wired local area network, a wireless wide area network, a wired wide area network, etc. In some embodiments, the communication subsystem may allow the computing device to send and/or receive messages to and/or from other devices via a network such as the Internet. In some embodiments, the communications between the various sources may require authentication to access the resources on a free or pay per use, or subscription model. It should be appreciated that the subject invention also includes encrypting the transmission of all information between the systems to ensure that the content as well as the personal information cannot be accessed except by authorized personnel or systems. The encryption schemes may use symmetric or asymmetric keys, as well as standard challenge response authentication, digital certificates and other commonly known encryption and methods used to secure access to digital resources.

Additionally, the custom programming server may execute or otherwise access internet search engine 170 to find content on content sources 120-126, in addition to utilizing the above-mentioned search engines 172-178 associated respectively with content sources 120-126. User inputs received via user inputs 155 may be processed into actionable search queries for standard search engine input as well as web service queries and other content discovery mechanisms. While the search engine 170 is depicted in FIG. 1 as residing on the custom programming server 130, it will be understood that the search engine also may be located remotely from the custom programming server 130.

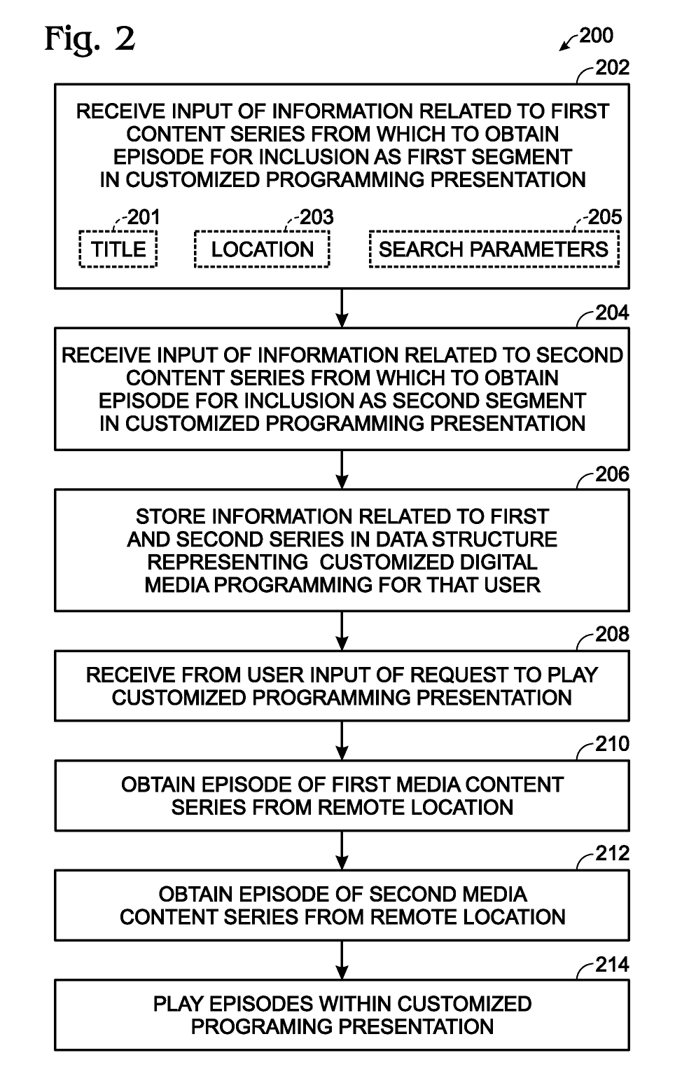

Continuing, FIG. 2 shows a flow diagram depicting an embodiment of a method 200 for presenting digital media via customized digital media programming. The term “customized programming,” “customized programming selection” and the like as used herein signifies a user-specified arrangement of content, while “customized programming presentation” and the like signifies a playback instance of a particular customized programming. Method 200 comprises, at 202, receiving an input of information related to (or attributes pertaining to the selection thereof) a first content series from which to obtain an episode for inclusion as first segment in a customized programming presentation. Examples of such information include, but are not limited to, a title 201 of the series and a network location 203 (e.g., a uniform resource locator (URL), peer-to-peer stream torrent information, etc.) at which the episode or episodes of the first content series may be obtained, and search parameters 205 to derive the identity and/or location of content via relevant search results. In such embodiments, the results can be presented in sequential order with highest relevancy or use crowd sourcing information or user feedback scoring to improve the overall accuracy of the content selected from all the available choices, or in any other suitable order. Method 202 further may store attributes describing the content selected locally or in a cloud service to prevent duplicate content being presented.

Method 200 next comprises, at 204, receiving an input of information related to a second content series from which to obtain an episode for inclusion as a second segment in the customized programming presentation. It will be understood that the first and second content series may be provided by a same or a different content source, and at a same or a different network location. The first and second content series define two segments of a customized programming presentation to be presented as a contiguous presentation. It should be appreciated if the input criteria for the second content series do not return sufficient results it can be skipped in the playback sequence.

It will be understood that a customized programming selection defined by a user may include any suitable number of episodes from any suitable number of content series. As such, the user input received at 202 and 204 may take the form of an input of a list of two or more locations of, identities of, search parameters related to, and/or other information regarding digital media content sources from which to obtain episodes of media content series for inclusion in a customized programming presentation. Likewise, it will be understood that a user may input any suitable number of such lists to define any suitable number of customized programming selections.

In some embodiments, a user may enter other information than locations, identities, search terms, and other information related to the identification or discovery of series from which episodes are to be obtained for customized programming presentations. For example, a user may specify an operating platform for each customized programming selection defined by the user. As such, if a user accesses the custom programming via devices that utilize different platforms, the user may consume customized programming presentations that the user set up for that particular platform. As a more specific example, a user may define a first set of customized programming selections for a television system, and a second set of customized programming selections for a mobile device, such that the first set of customized programming selections are intended for viewing while the second set of customized programming selections are intended for listening. As such, the user input may define, in addition to a platform, a format (e.g., an audio and/or video compression and/or resolution) for each content series episode to be obtained.

As another example, a user may specify one or more keywords to be utilized for obtaining the episodes for customized programming presentations. Such keywords may comprise any suitable type of keyword. For example, the one or more keywords may comprise an inclusionary keyword used as a filter to obtain episodes having an associated keyword that matches the inclusionary keyword. As a more specific example, a user may specify, as an inclusionary keyword, a particular sports team, so as to customize their programming presentation to include episodes relating to that team. Likewise, such keywords may comprise an exclusionary keyword used as a filter to prevent obtaining episodes having an associated keyword that matches the exclusionary keyword. For example, a user may specify, as an exclusionary keyword, a particular topic (e.g., homicide) so as to customize their programming presentation to exclude episodes relating to that topic.

As yet another example, a user may specify various time limits for further customizing a programming presentation. For example, a user may specify a maximum segment time limit for one or more segments of the customized programming presentation, and/or a maximum overall time limit for the customized programming presentation. In this way, the user may not only customize the format, platform, content, etc. of their programming presentations, but also the duration. It should be appreciated that such time limits may be input in any suitable format, such as a magnitude of time (e.g., five minutes). Further, in some embodiments, time limits may be input as a window of time (e.g., 5:00 pm-5:45 pm) to indicate a desired time for scheduled playback of a segment or segments of the customized programming presentation. Such time limits may also be utilized to indicate a desired ordering for presentation of the segments within the customized programming presentation.

Further, a content provider may provide index points to prioritize the content being delivered. For example, the content provider may specify for a content item that minutes 0-3 are the introduction, minutes 4-12 are primary content, minutes 13-15 are review, minutes 16-20 describe further research, and minutes 21-25 are production credits. Then, if a user wishes to ignore review content and the production credits, the user may not include the corresponding time segments in custom programming. Further, if addition of the content doesn't quite fit the user time slot, the time slots and/or the content it may be adjusted, for example, by dropping a few frames and compressing the overall time required to present the material.

As yet another example, a user may input demographic information. Such demographic information may be utilized for obtaining advertising information for inclusion in the customized programming presentation (e.g., to place relevant content in situ). Such advertising may be for inclusion in any suitable manner, such as presentation within one or more segments of the customized programming presentation and/or between the segments. It should be appreciated that the advertising information included in a segment may be of any suitable form, including banner advertisements, product placements in the virtual environment (e.g., via greenspace technology), etc. Such demographic information may also be utilized for subscribing to content.

In some embodiments, a user may specify social network information for a social network to which the user belongs. Such information may be utilized for obtaining programming recommended by the user's friends within the social network. Supporting such aspects of social engineering/crowd sourcing may facilitate the discovery of higher quality content relevant to that user's interests.

As yet another example, a user may input ratings information for a segment in a customized programming selection. Such information may be utilized as a filter to be applied against episodes for inclusion in a customized programming presentation, such that episodes with a specified quality rating (e.g., 4 of 5 stars) are obtained for a customized programming presentation.

Method 200 next comprises, at 206, storing the information related to the first and second series in a data structure representing customized digital media programming for that user. Storing the information in a data structure may include storing any suitable inputs received from the user, such as a network location or stream torrent at which episodes of the series may be obtained, a title of the series, search parameters for use in identifying series, etc. Further, other information received from the user also may be stored in the data structure, including but not limited to information related to platform, format, keywords, maximum segment time limits, maximum time limit for a customized programming presentation, demographic information, social networking information, ratings information, etc.

It should be appreciated that the data structure may have any suitable form. For example, in some embodiments, the data structure may comprise a markup document, such as an extensible markup language (XML) document. One non-limiting example of a suitable data structure represented in XML is shown below. In this example, the data structure represents customized news programming from online content sources, as well as traditional television content, for consumption on a television or smart phone.

<?xml version=″1.0″ encoding=″utf-8″?>
<Root>

<Display platform=″TV″>

<Role type=″home″>

<Access type=″weekday″>

<Program type=″News″>
<Segment>

<Start type=″UTC-7″>17:00:00</Start>
<Channel =″CNN Headline News″ url=www.cnn.com format=”hd

video” bonus_time=”10 minutes”>

<Stop type=″UTC-7″>17:10:00</Stop>

</Segment>
<Segment>

<Start type=″UTC-7″>17:10:00</Start>
<Channel =″KOMO Headline News″ url=www.komotv.com

format=”hd video” topic_exclude=”house fire” type=”download”>

<Stop type=″UTC-7″>17:15:00</Stop>

</Segment>
<Segment>

<Start type=″UTC-7″>17:15:00</Start>
<Channel =″StreamTorrent of the Day” type=”streamTorrent”

st=”st://A1UCgqwEfU1DTQZCoAHIfAsNWO/Nx8R313aIK4fg2sFJlhdeVEJ
UIEhRQkVSIC0asdf3Lm15cDJwZm9ydW0uZXWKQQdkZWZhdWx0iqIHR
2VuZXJhbA==” >

<Stop type=″UTC-7″>17:20:00</Stop>

</Segment>
<Segment>

<Start type=″UTC-7″>17:20:00</Start>
<Channel =″G4 Gaming News″ url=”www.g4tv.com” topic=”mobile”

topic=”xbox 360” format=”hd video”>

<Stop type=″UTC-7″>17:30:00</Stop>

</Segment>
<Segment>

<Start type=″UTC-7″>17:30:00</Start>
<Channel =″Tom's Hardware″ url=”www.tomshardware.com”

topic=”CPU Performance” rank=”3” format=”hd video”>

<Stop type=″UTC-7″>17:40:00</Stop>

</Segment>
<Segment>

<Start type=″UTC-7″>17:40:00</Start>
<Channel =″BBC Technology News″ url=www.bbc.uk format=”hd

video”>

<Stop type=″UTC-7″>17:50:00</Stop>

</Segment>
<Segment>

<Start type=″UTC-7″>17:50:00</Start>
<Channel =″Gizmodo Technology News″ uri=www.gizmodo.com

format=”hd video”>

<Stop type=″UTC-7″>17:55:00</Stop>

</Segment>
<Segment>

<Start type=″UTC-7″>17:55:00</Start>
<Channel =″Engadget Technology News″ uri=www.engadget.com

format=”hd video”>

<Stop type=″UTC-7″>18:00:00</Stop>

</Segment>

</Access>

</Role>

</Display>
<Display platform=″Smart Phone″>

<Role type=″Drive″>

<Access type=″weekday″>

<Segment>
<Program type=″News″ format=”audio”>
<Start type=″UTC-7″>08:00:00</Start>
<Channel =″KOMO Traffic News″>
<Stop type=″UTC-7″>08:05:00</Stop>
</Segment>
<Segment>
<Start type=″UTC-7″>08:05:00</Start>
<Channel =″K5 Traffic News″>
<Stop type=″UTC-7″>08:10:00</Stop>
</Segment>
<Segment>
<Start type=″UTC-7″>08:10:00</Start>
<Channel =″Engadget″ url=www.engadget.com format=”mp3”;

topic=”gaming news”; topic=”Microsoft”; bonus_time=”30 minutes”>

<Stop type=″UTC-7″>08:10:00</Stop>
</Segment>
<Segment>
<Start type=″UTC-7″>08:10:00</Start>
<Channel =″Weather Channel″>
<Stop type=″UTC-7″>08:15:00</Stop>
</Segment>

<Advertisement>

<Demographics>

<Marital>Single</Marital>
<Kids>

<Age>5</Age>
<Age>9</Age>
<Age>15</Age>

</Kids>
<Homeowner>Yes</Homeowner>
<Income>65000</Income>

</Demographics>

<Automobile>BMW</Automobile>
<Interests>Broadband</Interests>
<Interests>Travel</Interests>
<Interests>Solar Power</Interests>

</Advertisement>

</Access>

</Role>

</Display>

</Root>

This example data structure illustrates two different custom programming selections for news presentations, wherein each customized programming selection is for a different platform, namely a television platform and a smart phone platform. For the television platform, the user has identified series from which to obtain episodes by various news URLs and peer-to-peer stream torrents, and has specified each segment for each series to have a maximum playback time on the order of 5-15 minutes. The user has specified a high definition (HD) video format for each of these segments. Further, it can be seen that the user has specified an exclusionary keyword “house fire” (in the form of topic_exclude=“house fire”>) from a local news presentation, thereby excluding episodes having topic keywords that match this keyword. In this way, the user may be able to avoid consuming news regarding house fires. The user can define their preference to stream the content or download and cache locally on the device in the form of the type=“download” or type=“streamTorrnet” preference. The server may also choose to provide indications to the client of the appropriate type by the file extension available on the server or peer to peer client.

Next, for the smart phone platform, the user has specified series for inclusion as segments by both network URL and by station name, wherein the segments identified by station name correspond to broadcast media stations to be tuned in for the specified time window. Inclusionary keywords are also shown, one example of which is topic=“gaming news”. The depicted example data structure also comprises user demographic information for obtaining advertising information for inclusion in the user's customized programming presentation. It should be appreciated that this example XML data structure is illustrative, and not intended to be limiting in any way.

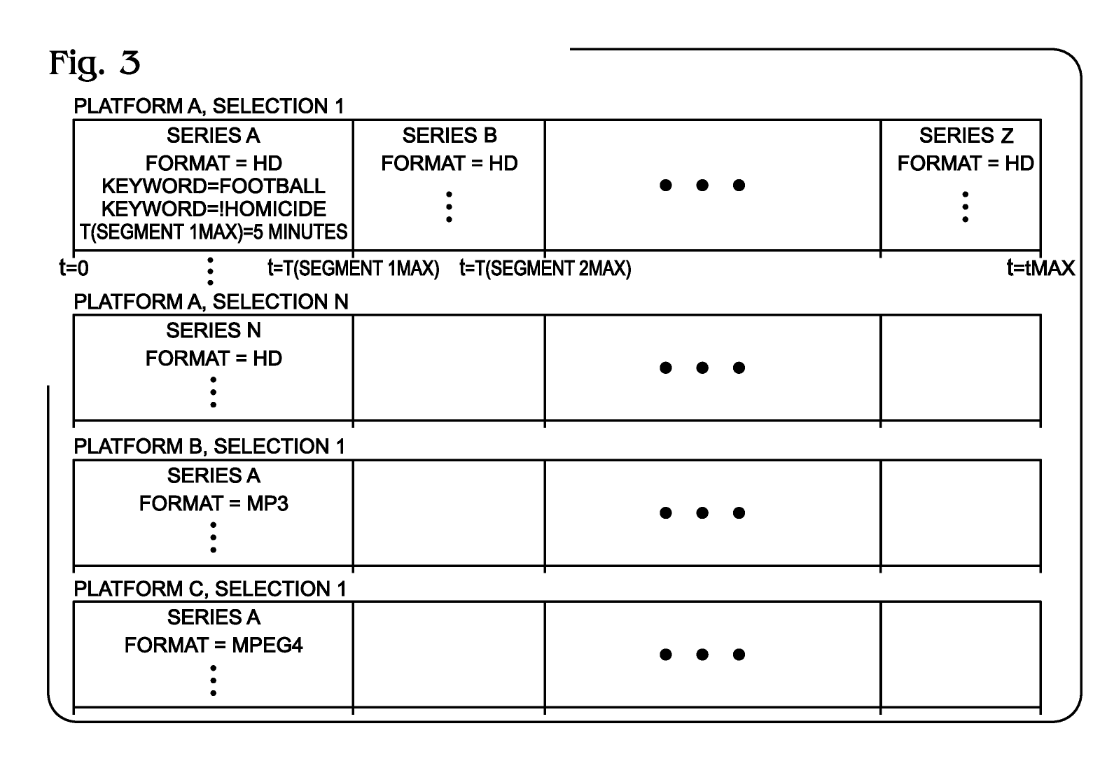

FIG. 3 shows an example schematic depiction of embodiments of custom media programming selections defined by a user. Each custom media programming selection may be selected by a user to play back a corresponding customized programming presentation, and each media content series in each customized media programming selection corresponds to a segment to be obtained for a corresponding customized programming presentation. In this example, selections associated with three platforms are illustrated, namely platforms A, B, and C, which may, for example, correspond to computer 102, mobile device 104, and television system 106.

Each selection identifies series from which episodes are to be obtained. For example, selection 1 for platform A obtains episodes from series A, series B, . . . , series Z. The identify information associated with each series within the selection indicates how an episode of the series is to be obtained. For example, within selection 1 for platform A, a 5-minute episode is to be obtained from series A in an HD format if the episode has a keyword matching the inclusionary keyword of “football”, and if it doesn't have the exclusionary keyword “homicide.”

A user may specify any desired number of customized media programming selections for a platform. This is illustrated in FIG. 3 for platform A, which has an arbitrary number N of different customized digital programming selections defined. In this manner, customized programming selections may be defined for various topics of interest, such as news, sports, comedy, etc.

It will be understood that a particular series may be available in various different formats to support playback on different platforms. As such, FIG. 3 depicts series A being included in customized programming selections for each depicted platform, where each platform utilizes a different specified format (e.g., HD, MP3 and MPEG4). For example, MPEG-4 could be specified for viewing on platforms with screens, while MP3 could be specified for viewing on platforms without screens. In this way, the selection is appropriately configured for presentation on a specified platform. As a further example, a user may choose to not utilize the full capability of the display screen for video playback and merely listen to the audio portion of the MPEG4 as the preferred presentation format thereby conserving battery power during playback.

Continuing with method 200 of FIG. 2, in some embodiments, method 200 may further include sending the data structure representing customized digital media programming to a remote server (e.g., custom programming server 130 of FIG. 1) for storage. In this manner, the customized digital media programming may be synchronized across user devices as user devices connect to the custom programming server during use sessions. In this manner, a user may obtain a most-recently updated version of the customized digital media programming for consumption on any suitable device. In other embodiments, the data structure may be stored locally.

Method 200 next comprises, at 208, receiving from the user input of a request to play the customized programming presentation. The input may be received via a customized programming presentation application, for example, which communicates with the custom programming server, presents a user interface showing selections available for the current platform, and obtains and aggregates episodes of specified series to play a customized media presentation. In embodiments where the data structure is stored at a remote server, method 200 may further include, before receiving the user input of a request to play the customized programming presentation, receiving a user request to obtain the data structure (e.g. when the user launches the customized programming presentation application), sending a request to the remote server for the data structure, receiving the data structure, and presenting a user interface showing customized programming selections available for that platform.

Further, in some embodiments, upon receiving the input, method 200 may further comprise obtaining advertising information based on demographic information (e.g., stored within the data structure). Such advertising information may be obtained for inclusion in the customized programming presentation.

Method 200 next comprises, at 210, obtaining an episode of a first digital media content series specified in the customized media selection. Such an episode may be obtained from a remote location specified in the identity of the first content series as stored in the data structure. As mentioned above, the location may be a network location; a broadcast channel combined with a specified time window, or may be any other suitable location information. Further, in some embodiments, obtaining the episode of the first digital media content series may comprise comparing an inclusionary keyword to keywords associated with episodes of the first digital media content series to obtain an episode having a matching keyword, and/or comparing an exclusionary keyword to avoid obtaining an episode having a matching keyword. The episode selection may even include a “top link” of the day, a random selection, or other such content discovery mechanisms.

It will be understood that the episodes that make up a customized programming presentation may be obtained and stored/aggregated on the end user device, or may be obtained and aggregated via the custom programming server (or other server device). Where the content is obtained and aggregated on the custom programming server, the customized programming presentation may be streamed to the user for playback.

Method 200 next comprises, at 212, obtaining an episode of the second digital media content series from remote location, and then, at 214, providing the obtained episodes of the first and second content series within a contiguous customized programming presentation that may or may not include episodes of additional content series obtained in the same manner as the episodes of the first and second content series. It will be understood that the term “providing” may represent either playing the presentation on an end-user device, or providing the presentation from a server to an end-user device for playback. In embodiments wherein advertising information based on demographic information is obtained, method 200 may further include presenting the advertising information as part of the customized programming presentation. It should be appreciated that such advertising information may be presented in any suitable way, including between the first and second segment and/or between other segments, and/or within the first segment or the second segment or other segments.

It should be appreciated that in some embodiments if the remote server is not available or goes offline during playback the system can continue play with the next segment. In addition the system may download the content to a local device or aggregate on a remote server and then download to the device. Likewise, the device may participate in peer to peer networks sharing segments of the content. Further, the device may stream some or all segments based upon user preferences expressed through the configuration settings.

It also should be appreciated that the device performing the playback of each episode can persist the actual content or metadata pointing to the content presented to support pause/resume in the future, as well as prevent duplication of content if different discovery services return the same content. Such a history may allow a user to review previously-obtained and/or viewed material in the future. The information related to the episodes displayed can also be stored online and made available to ensure that the most up to date information on the content already shown or current progress is shared across the various devices.

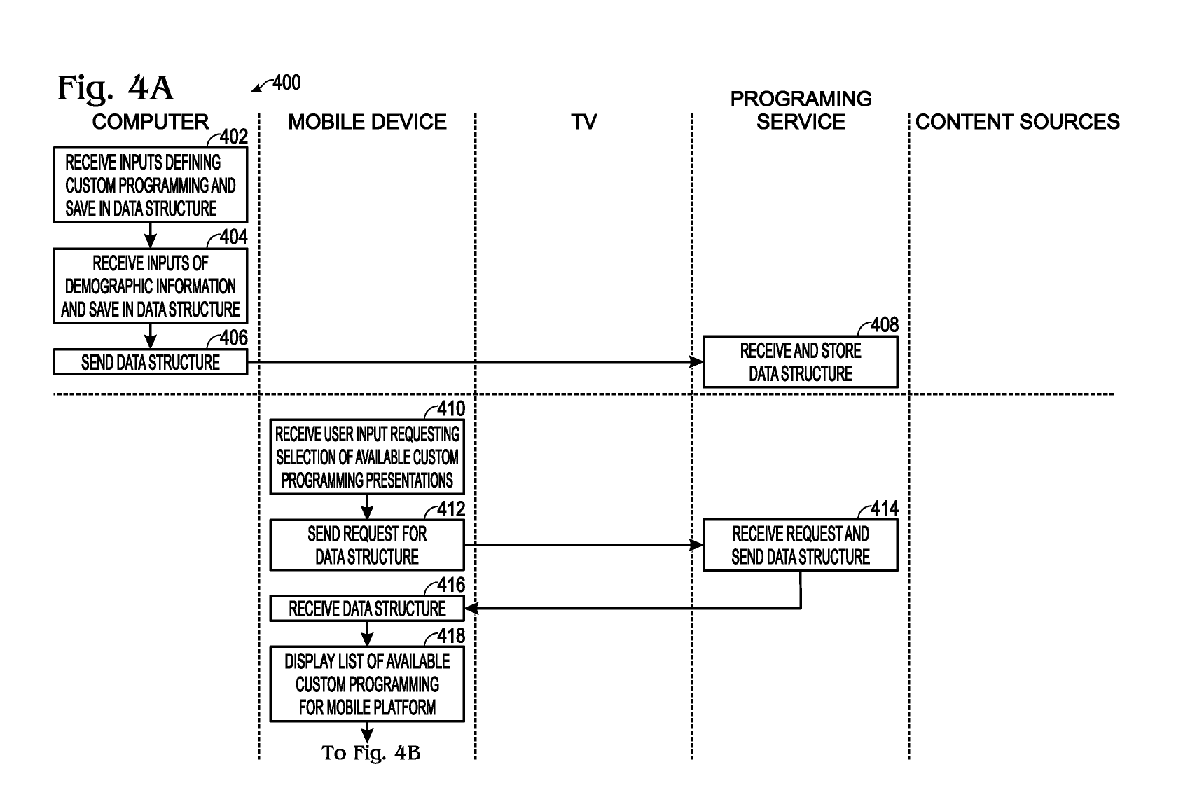

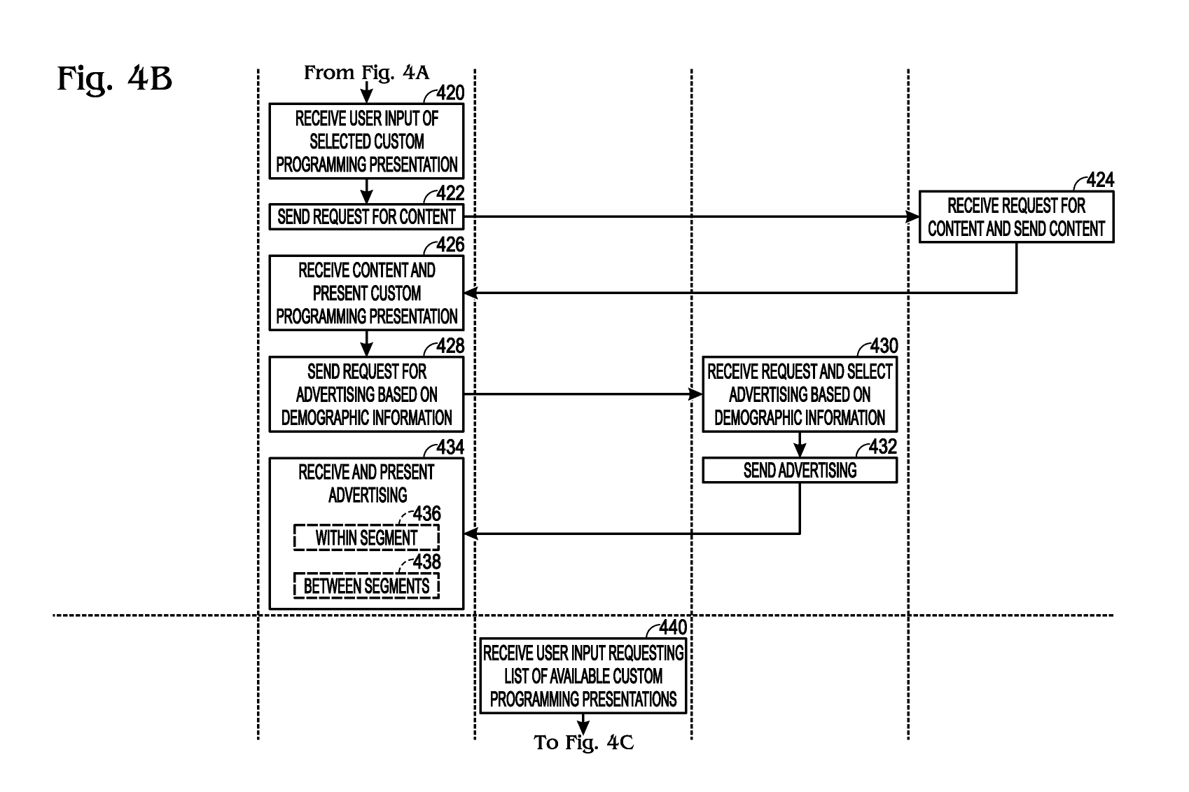

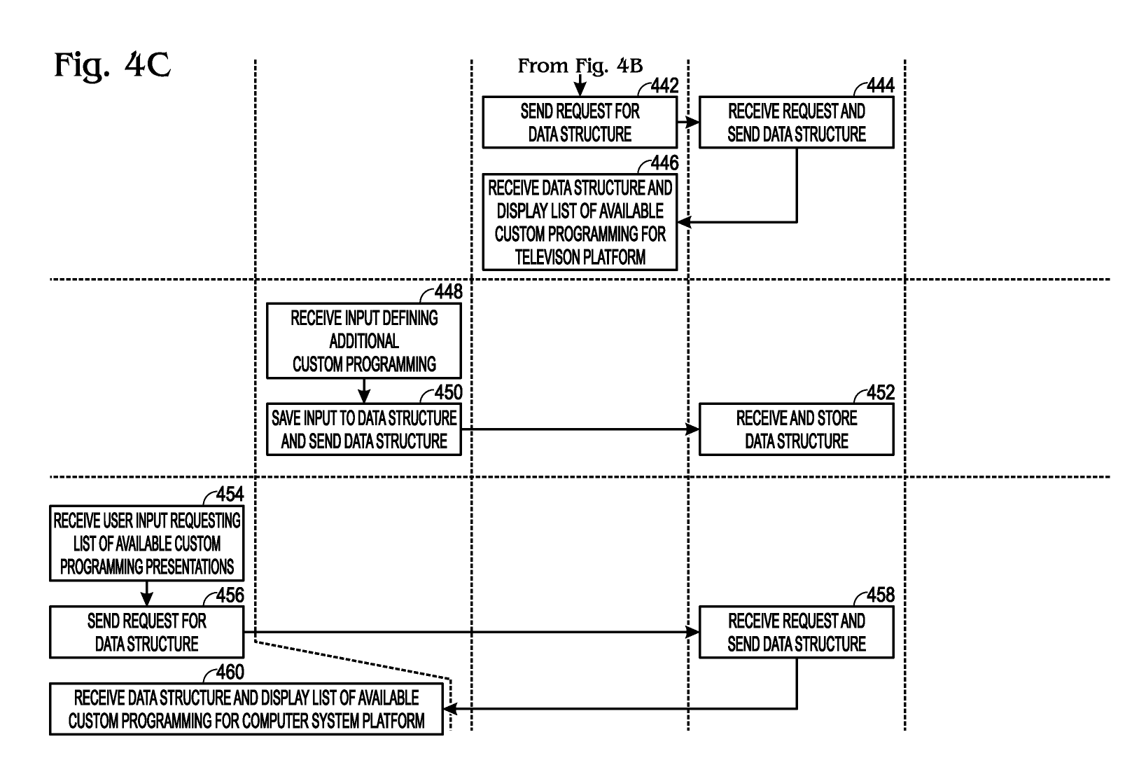

FIGS. 4A-4C show a flow diagram depicting another, more detailed embodiment of a method of presenting customized digital media content programming.

Beginning with FIG. 4A, at 402-408 of the method, the customized programming is defined by a user as follows. At 402, inputs defining customized programming are received at a computer. Such inputs may include any suitable information for defining customized programming, and may include programming for presentation on different platforms. For example, an input may be received of a first selection of two or more locations of digital media content sources from which to obtain episodes of media content series for inclusion in customized programming presentation. Such inputs may also define a first platform (e.g., a computer platform) for presenting a first customized programming presentation, a second platform (e.g., a mobile device platform) for presenting a second customized programming presentation, and a third platform for presenting a third customized programming presentation (e.g., a television system platform). These inputs are then stored in a data structure defining customized digital media programming. It will be understood that any suitable number of customized programming selections may be defined for each platform. In addition the inputs are shown to be originating at a computer, it will be understood that any computational device or cloud service, web site, etc. can be used to configure the input which results in the selection of content.

Method 400 next proceeds to 404, where the computer receives an input of demographic information, and saves the demographic information in the data structure. The demographic information may be explicitly disclosed, skipped entirely, or derived based upon location. Next, at 406, the computer sends the data structure to a customized programming service on a remote server. At 408, the programming service receives and stores the data structure. It will be understood that the programming service may receive and store data structures from each user of a plurality of users.

It should be appreciated the programming service may be executed locally on the device and leverage discovery/search engines to obtain the links to the actual content of interested to the user(s).

At 410-438 of the method, the customized programming may be selected and presented via the mobile device as follows. At 410, a user input requesting a list of available customized programming presentations is received at the mobile device. In response, at 412, a request for a data structure is sent to the programming service. At 414, the request is received at the programming service, and the data structure is sent to the mobile device. At 416, the mobile device receives the data structure, and at 418, a list of available customized programming for the mobile platform is displayed at the mobile device.

Alternatively the device may query discovery services directly such as performing a search on YouTube for music artists of interest to the user and retrieve a compendium of greatest hits URL all of which are compiled into a playlist and presented in order of the popularity of each segments viewing.

Next, at 420 of FIG. 4B, a user input requesting presentation of a selected customized programming presentation is received at the mobile device. Next, at 422, requests for content associated with the selected customized programming presentation are sent to remote content sources (this is illustrated by a single request in FIG. 4B, but it will be understood that any suitable number of requests may be sent to any suitable number of content sources). At 424, the requests for content are received by the content sources, and the content is sent to the mobile device. Next, at 426, the content is received at the mobile device and aggregated into a customized programming presentation, and the customized programming presentation is presented at the mobile device.

Next, at 428, a request for advertising based on demographic information is sent from the mobile device to the programming service. At 430, the programming service receives the request, selects advertising based on the demographic information, and sends the advertising to the mobile device at 432. At 434, the mobile device receives the advertising, and presents the advertising within the customized programming presentation. In some embodiments, the advertising may be presented within a particular segment of the customized programming presentation, as indicated at 436. While in other embodiments, the advertising may be presented between segments of the customized programming presentation, as indicated at 438.

Next, the selection and presentation of the customized programming via a television system is illustrated at 440-446. At 440, the television system receives a user input requesting to view a list of available customized programming presentations. The list of programming presentations may be filtered or selected based upon keyword attributes. The method next proceeds to 442 of FIG. 4C, where the television system sends a request for the data structure to the programming service. At 444, the programming service receives the request, and sends the data structure to the television system. At 446, the television system receives the data structure, and displays a list of available customized programming for the television platform.

Next, the updating of the customized programming by the user via the user's mobile device is shown at 448-452. First, at 448, the mobile device receives an input defining additional customized programming, and at 450, saves the input to the data structure and sends the data structure to the programming service. Next, at 452, the programming service receives and stores the data structure for access by requesting devices.

At 454-460, the selection and presentation of the updated customized presentation by the computer is illustrated. At 454, the computer receives a user input requesting a list of available customized programming presentations, and at 456, the computer sends a request to the programming service for the data structure. Next, at 458, the programming service receives the request and sends the data structure to the computer. Then, at 460, the computer receives the data structure, and displays a list of available custom programming for the television system platform.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. On a computing device, a method of presenting digital media content, the method comprising:
receiving an input of information regarding a first digital media content series from which to obtain an episode for inclusion as a first segment in a contiguous customized programming presentation for a user;
receiving an input of information regarding a second digital media content series from which to obtain an episode for inclusion as a second segment in the customized programming presentation;
storing the information regarding the first digital media content series and the information regarding the second digital media content series in a data structure representing customized digital media programming for the user;
receiving from the user an input of a request to play the customized programming presentation;
obtaining an episode of the first digital media content series;
obtaining an episode of the second digital media content series; and
providing the episode of the first digital media content series and the episode of the second digital media content series within the customized programming presentation.

2. The method of claim 1, wherein receiving the input of the information regarding the first digital media content series comprises receiving an input of one or more of an identity of the first digital media content series, a search parameter related to the first digital media content series, a network location at which episodes of the first digital media content series are obtainable, and a peer-to-peer stream torrent via which episodes of the first digital media content series are available.

3. The method of claim 2, wherein the computing device is a server computing device, and wherein providing the episode of the first digital media content series and the episode of the second digital media content series comprises streaming the customized programming presentation to a requesting device.

4. The method of claim 1, wherein the computing device is a client computing device, and further comprising sending the data structure representing customized digital media programming to a remote server for storage.

5. The method of claim 4, further comprising, before receiving the input of the request to play the customized programming presentation, sending a request to the remote server for the data structure, and receiving the data structure.

6. The method of claim 4, wherein the customized programming presentation is a first customized programming presentation, further comprising receiving an input of a first platform type for the first customized programming presentation, and further comprising:
receiving from the user an input of information related to a third digital media content series and a fourth digital media content series from which to obtain an episode for inclusion as a segment in a second customized programming presentation; and
receiving from the user an input of a second platform type for the second customized programming presentation, wherein the second platform type is different than the first platform type.

7. The method of claim 4, further comprising, before receiving the input of the request to play the customized programming presentation, sending a request to the remote server for the data structure, receiving the data structure, and then presenting to the user a list of customized programming presentations available based upon a platform type of the computing device.

8. The method of claim 4, further comprising receiving an input of demographic information, and storing the demographic information in the data structure.

9. The method of claim 8, further comprising, after receiving the input of the request to play the customized programming presentation, obtaining advertising information based on the demographic information for inclusion in the customized programming presentation and presenting the advertising information as part of the customized programming presentation.

10. The method of claim 8, wherein presenting the advertising information comprises presenting the advertising information between the first segment and the second segment and/or presenting the advertising information within one or more of the first segment and the second segment.

11. The method of claim 1, further comprising receiving an input of one or more of a maximum segment time limit for one or more of the first segment and the second segment and a maximum overall time limit for the customized programming presentation for storage in the data structure.

12. The method of claim 1, further comprising receiving an input of one or more of an exclusionary keyword and an inclusionary keyword and saving the one or more of the exclusionary keyword and the inclusionary keyword in the data structure.

13. The method of claim 12, wherein obtaining the episode of the first digital media content series comprises comparing the exclusionary keyword to keywords associated with episodes of the first digital media content series, and not obtaining an episode of the first digital media content series having an associated keyword that matches the exclusionary keyword.

14. A computing device, comprising:
a logic subsystem; and
a data-holding subsystem comprising instructions stored thereon that are executable by the logic subsystem to perform a method of presenting digital media content, the method comprising:
receiving for each user of a plurality of users a data structure representing customized digital media programming, the customized digital media programming comprising one or more customized media programming selections, each customized media programming selection comprising a list of media content series from which episodes are to be obtained to form a corresponding customized programming presentation, wherein each media content series in each list corresponds to a segment in the corresponding customized programming presentation;
receiving from a remote computing device a request for the data structure representing customized digital media programming for a selected user; and
sending to the remote computing device the data structure representing the customized digital media programming for the selected user.

15. The computing device of claim 14, wherein the data structure comprises one or more of a platform specified for each selection, a maximum time limit specified for one or more customized programming presentations, a maximum segment time limit for one or more segments of one or more customized programming presentations, one or more exclusionary keywords, one or more inclusionary keywords, and a specified format for one or more segments.

16. The computing device of claim 14, wherein the instructions are further executable to encrypt communications with the remote computing device.

17. The computing device of claim 14, wherein the remote computing device is a first computing device associated with the selected user, and wherein the instructions are further executable to receive a request for the data structure for the selected user from a second computing device associated with the selected user and to send the data structure to the second computing device.

18. A computer-readable storage medium comprising instructions stored thereon that are executable by a computing device to perform a method of presenting digital media content, the method comprising:
receiving an input of a first customized media programming selection comprising a list of two or more locations of digital media content sources from which to obtain episodes of media content series for inclusion in a first customized programming presentation;
receiving an input defining a first platform for presenting the first customized programming presentation;
receiving an input of a second customized media programming selection comprising a list of two or more locations of digital media content sources from which to obtain episodes of media content series for inclusion in a second customized programming presentation;
receiving an input defining a second platform for presenting the second customized programming presentation;
storing the first custom media programming selection, an identity of the first platform, the second custom media programming selection, and an identity of the second platform in a data structure defining customized digital media programming;
sending the data structure to a remote server;
receiving a user input requesting to view available digital media programming;
sending a request to the remote server for the data structure;
receiving the data structure; and
presenting one of the first customized programming presentation and the second customized programming presentation based on a platform utilized by the computing device.

19. The computer-readable storage medium of claim 18, wherein the instructions are further executable to receive an input of demographic information, save the input of demographic information in the data structure, and obtain and present advertising based upon the demographic information.

20. The computer-readable storage medium of claim 18, wherein the instructions are further executable to receive an input of one or more of a platform specified for each selection, a maximum time limit specified for one or more customized programming presentations, a maximum segment time limit for one or more segments of one or more customized programming presentations, one or more exclusionary keywords, one or more inclusionary keywords, and a specified format for one or more segments of one or more customized programming presentations.
